(19) United States
(12) Patent Application Publication
(10) Pub. No.: US 2004/0194081 A1
(43) Pub. Date: Sep. 30, 2004

(54) Update system for facilitating firmware/software update in a mobile handset

(76) Inventors: Iyad Qumei, Huntington Beach, CA (US); Shao-Chun Chen, Aliso Viejo, CA (US)

Correspondence Address: MCANDREWS HELD & MALLOY, LTD, 500 WEST MADISON STREET, SUITE 3400, CHICAGO, IL, 60661

(21) Appl. No.: 10/770,983

(22) Filed: Feb. 3, 2004

Related U.S. Application Data
(60) Provisional application No. 60/444,459, filed on Feb. 3, 2003.

(30) Foreign Application Priority Data
Mar. 23, 2002 (WO) 02/41147 A1

(51) Int. Cl. G06F 9/44; G06F 9/445

(52) U.S. Cl. 717/173; 717/178

(57) ABSTRACT

An update system facilitates the download of update packages from a server and the subsequent update of firmware/software in a portable electronic device such as, for example, a mobile handset, with a file system. In one embodiment, an update driver populates an update package reference with appropriate information and flags, after the successful download and verification of an update package. An update agent in the mobile handset retrieves the update package employing the update package reference, and applies the update package to the firmware/software in the mobile handset. In one embodiment, a download agent in the mobile handset is executed as an unprivileged application that interacts with an update driver that is part of the kernel that executes in privileged mode and is capable of saving downloaded content, such as an update package, into the non-volatile memory employing one or more flash driver(s). The update driver may be employed by the mobile handset with the file system to communicate information about a downloaded update package to the update agent for subsequent firmware updates.

### RELATED APPLICATIONS

This patent application makes reference to, claims priority to and claims benefit from U.S. Provisional Patent Application Serial No. 60/444,459, entitled “Update System for Facilitating Firmware/Software Update in a Mobile Handset,” filed on Feb. 3, 2003.

The complete subject matter of the above-referenced U.S. Provisional Patent Application is hereby incorporated herein by reference, in its entirety. In addition, this application makes reference to U.S. patent application Ser. No. ______ (Attorney Docket No. 14327US02), entitled “Update System Capable of Updating Software Across Multiple Flash Chips,” filed Jan. 20, 2004, U.S. Provisional Patent Application Serial No. 60/424,041, entitled “Firmware Update System For Facilitating Firmware Update in Mobile Handset,” filed Nov. 5, 2002, U.S. Provisional Patent Application Serial No. 60/249,606, entitled “System and Method for Updating and Distributing Information”, filed Nov. 17, 2000, and International Patent Application Publication No. WO 02/41147 A1, entitled “Systems And Methods For Updating And Distributing Information,” publication date Mar. 23, 2002, the complete subject matter of each of which is hereby incorporated herein by reference, in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Electronic devices, such as mobile phones and personal digital assistants (PDA's), often contain firmware and application software that are either provided by the manufacturers of the electronic devices, by telecommunication carriers, or by third parties. These firmware and application software often contain software bugs. New versions of the firmware and software are periodically released to fix the bugs or to introduce new features, or both.

Problems may arise when supporting firmware updates in devices that contain file systems. For example, the location of information stored in such a file system often needs to be communicated to low level drivers or firmware components that need to access such information before any operating system services such as, for example, file systems, are available. There may also be a need to communicate status information to low-level drivers or firmware components before the operating system services that support such communication are available, for example, during power up or reboot.

Further limitations and disadvantages of conventional and traditional approaches will become apparent to one of ordinary skill in the art through comparison of such systems with the present invention.

### BRIEF SUMMARY OF THE INVENTION

Aspects of the present invention may be seen in a system that facilitates updating of firmware in an electronic device with a file system, using updating information received from a server via a communication network. The system comprises a non-volatile memory comprising the firmware; an operating system that supports a file system; loading software that receives the updating information; driver software that stores the loaded updating information in the non-volatile memory; and updating software that applies the updating information to the firmware.

In an embodiment of the present invention, the driver software stores information associated with the updating information at a reference location in the non-volatile memory. The updating software employs the information associated with the updating information to retrieve the updating information.

In an embodiment of the present invention, the system also comprises a multiprocessing kernel that executes in a privileged mode. The kernel may determine whether updating of the firmware in the electronic device is necessary, when the electronic device is initialized. The kernel may also determine whether updating information is available and invoke the updating software to update the firmware if it determines that updating information is available.

In an embodiment of the present invention, the system also comprises a library, and the driver software and updating software utilize the library to read and write data from the non-volatile memory.

In an embodiment of the present invention, the updating information is stored in a continuous block of the non-volatile memory, which may not be used for data storage and retrieval.

These and other features and advantages of the present invention may be appreciated from a review of the following detailed description of the present invention, along with the accompanying figures in which like reference numerals refer to like parts throughout.

### BRIEF DESCRIPTION OF SEVERAL VIEWS OF THE DRAWINGS

FIG. 1 illustrates a block diagram of an exemplary update system for facilitating firmware/software updates in a mobile handset, in accordance with an embodiment of the present invention.

FIG. 2 illustrates a block diagram of the layered architecture of a mobile handset in an exemplary update system for facilitating firmware/software updates in a mobile handset, in accordance with an embodiment of the present invention.

FIG. 3 illustrates a block diagram of the layered architecture of a mobile handset in another exemplary update system for facilitating firmware/software updates in a mobile handset, in accordance with an embodiment of the present invention.

FIG. 4 illustrates a block diagram of the layered architecture of a mobile handset in another exemplary update system for facilitating firmware/software updates in a mobile handset, in accordance with an embodiment of the present invention.

FIG. 5 illustrates a block diagram of the layered architecture of a mobile handset in another exemplary update system for facilitating firmware/software updates in a mobile handset, in accordance with an embodiment of the present invention.

FIG. 6 illustrates a block diagram of the layered architecture of a mobile handset in another exemplary update system for facilitating firmware/software updates in a mobile handset, in accordance with an embodiment of the present invention.

### DETAILED DESCRIPTION OF THE INVENTION

The present invention relates generally to updates of firmware/software components in electronic devices such as, for example, mobile handsets, and specifically to the update of firmware/software from one version to another in mobile handsets and other constrained devices, especially those with file systems. Although the following discusses aspects of the invention in terms of a mobile handset, it should be clear that the following discussion also applies to other mobile electronic devices such as, for example, personal digital assistants (PDAs), pagers, personal computers (PCs), and similar handheld electronic devices.

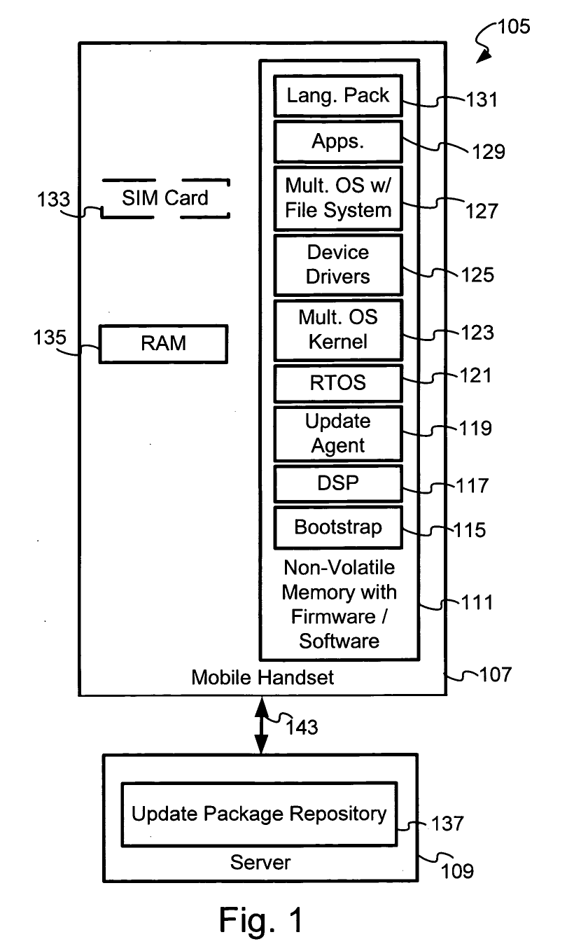

FIG. 1 illustrates a block diagram of an exemplary update system 105 for facilitating firmware/software updates in a mobile handset 107, in accordance with an embodiment of the present invention. The update system 105 may comprise a mobile handset 107, with a file system, connected to a server 109 via a communication link 143. In an embodiment of the present invention, the server 109 may host an update package repository 137, which may contain update packages for firmware/software in mobile handsets such as mobile handset 107 connected to the server 109. In an embodiment of the present invention, an update package may contain information needed to upgrade firmware/software in the mobile handset 107 from one version to another.

In an embodiment of the present invention, the mobile handset 107 may comprise a non-volatile memory 111 with firmware/software, and a random access memory (RAM) 135. In an embodiment of the present invention, the mobile handset 107 may also comprise a subscriber identity module (SIM) card 133. In an embodiment of the present invention, the non-volatile memory 111 may comprise firmware/software such as, for example, bootstrap code 115, digital signal processing (DSP) code 117, an update agent 119, a real-time operating system (RTOS) 121, a multiprocessing operating system kernel 123, device drivers modules 125, a multiprocessing operating system with file system 127, an applications layer 129, and a language pack 131.

In an embodiment of the present invention, the mobile handset 107 may facilitate retrieval of update packages from an external system such as, for example, the update package repository 137 in the server 109. In another embodiment of the present invention, the mobile handset 107 may retrieve update packages from a local file system in the mobile handset 107 such as, for example, the multiprocessing operating system with file system 127. The mobile handset 107 may employ the update agent 119 to apply the retrieved update packages to the firmware/software in the mobile handset 107.

In an embodiment of the present invention, the update agent 119 may retrieve an update package employing update package-related information. The update package-related information may be stored in an update package reference. The update package-related information may comprise information such as, for example, an update package location address, a working bank address, verification information, and a status flag. The update agent 119 may retrieve update package-related information from an update package reference, which may be stored in the non-volatile memory 111. The update package reference may be populated into the non-volatile memory 111 by an update driver, which may be part of the device drivers 125, responsible for saving an update package. In another embodiment of the present invention, the update package reference may be populated into the non-volatile memory 111 by software capable of downloading an update package and saving information related to the downloaded update package. In another embodiment of the present invention, the update package reference may be found in the SIM card 133.

In an embodiment of the present invention, the update driver may be employed by the mobile handset 107 to store an update package in the file system. In another embodiment of the present invention, the update driver may be employed by the mobile handset 107 to store an update package in a location outside the control of the local file system. The update driver may populate the update package reference with appropriate values following storage of the update package.

In an embodiment of the present invention, the update package reference may be located at a default location in the non-volatile memory 111. In another embodiment of the present invention, the update package reference may be located in a file, with a default name, in the local file system. In an embodiment of the present invention, the update package reference may occupy, for example, a 16-byte space in the non-volatile memory 111. In an embodiment of the present invention, for example, such a 16-byte space may comprise a 4-byte address indicating the location of an update package in the non-volatile memory 111, another 4-byte address indicating the location of the backup memory bank used for fault tolerant updates, another 4-byte address indicating the location of the verification information such as, for example, a cyclic redundancy code (CRC) value or a MD5 checksum, and another 4-byte address indicating the location of an update status flag.

In an embodiment of the present invention, the update agent 119 may perform memory management on itself; as such services normally provided by an operating system may not be available to it. The update agent 119 may comprise flash management libraries such as, for example, functions for erasing and writing to flash memory. In an embodiment of the present invention, the flash management libraries may be written for individual flash modules, and the update agent 119 may incorporate flash libraries for several flash memory make models. For example, the update agent 119 may incorporate flash libraries for specific flash memory devices such as, for example, the AMD AM29BDS323D and the Intel 28F128W18 flash memory chips. An example of an approach for accessing flash memory is described in U.S. patent application Ser. No. ______ (Attorney Docket No. 14327US02), entitled “Update System Capable of Updating Software Across Multiple Flash Chips,” filed Jan. 20, 2004; the complete subject matter of which is hereby incorporated herein by reference, in its entirety.

In an embodiment of the present invention, the update agent 119 may comprise user interface and debug wrapper functions. Wrapper functions may be functions utilized to indirectly access proprietary information or code stored in hardware devices (e.g., registers). The user interface and debug wrapper functions may support a level of interaction with a user sufficient to provide feedback regarding an update activity such as, for example, display of information about different update stages and display of a progress bar.

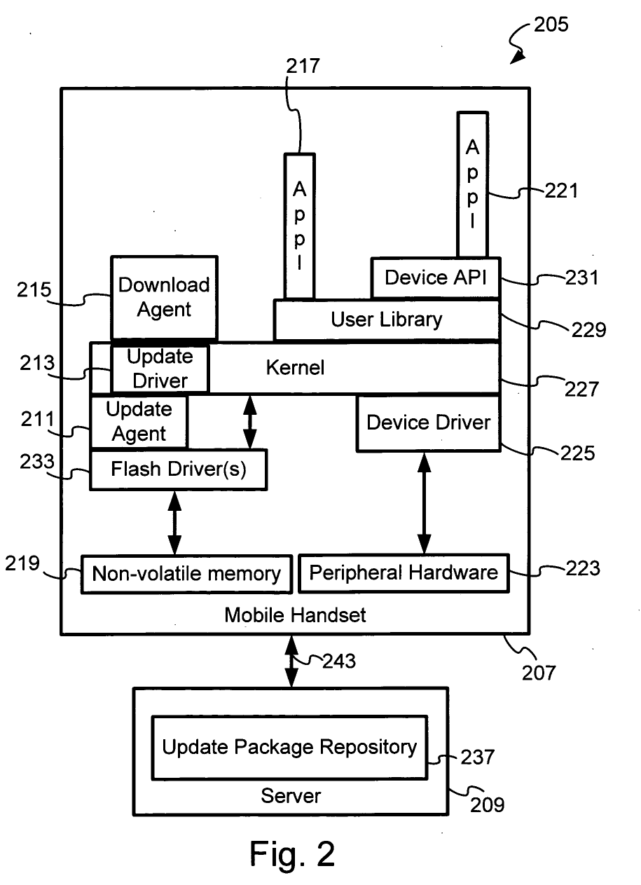

FIG. 2 illustrates a block diagram of the layered architecture of a mobile handset 207 in an exemplary update system 205 for facilitating firmware/software updates in a mobile handset 207, in accordance with an embodiment of the present invention. The update system 205 may comprise a mobile handset 207, with a file system, connected to a server 209 via a communication link 243. In an embodiment of the present invention, the server 209 may host an update package repository 237, which may contain update packages for firmware/software in mobile handsets such as mobile handset 207 connected to the server 209.

In an embodiment of the present invention, the mobile handset 207 may include a file system such as, for example, that provided by Symbian OS developed by Symbian Ltd. The operating firmware/software of the mobile handset 207 may comprise several layers of firmware/software. The update of firmware/software may be achieved using an update agent 211. The operating system may have a kernel 227 that is a compact pre-emptive multitasking operating system with little dependence on peripherals. For example, in the Symbian OS, the core kernel executable is less than 200 kB, and fully supports the multi-threaded operating system. In an embodiment of the present invention, the integration of hardware peripherals 223 may be added to the kernel 227 by using device drivers 225. The device drivers 225 may be provided by a kernel on which the OS is configured. In an embodiment of the present invention, hardware support may be implemented in separate dynamic link libraries (DLLs) associated with particular hardware such as, for example, video graphics chips or a modem chipset, to allow easy insertion and removal of hardware and to facilitate code reuse.

In an embodiment of the present invention, when an operating system such as, for example, the Symbian OS is employed, programs may be executed in privileged mode or in a non-privileged mode. A memory management unit (MMU) may be configured such that all hardware registers may only be accessed in privileged mode. In an embodiment of the present invention, the kernel 227 may only execute in privileged mode, and hence may have access to all the hardware registers. Applications 221 may interface to kernel services through a device application-program interface (API) 231, which may be provided by the user library 229. In an embodiment of the present invention, at least a portion of the applications may run in a non-privileged mode. Hence operations that require hardware access may switch momentarily into privileged mode while maintaining the context of the application or issue a request to the kernel server, which may require a switch in context to that of the kernel process.

In an embodiment of the present invention, the kernel 227 may include support for peripheral hardware 223 that may reside on a device such as, for example, an application-specific integrated circuit (ASIC), and that may be essential to the operating system. The peripheral hardware 223 may include components such as, for example, timers, direct memory access (DMA) engines, interrupt controllers, and universal asynchronous receiver-transmitter (UART) serial ports. The kernel 227 may be customized for a particular device such as, for example, an ARM 7 processor supplied by ARM Ltd. In an embodiment of the present invention, applications 217 and application 221 may not access peripheral hardware 223 directly. Instead applications 217 and applications 221 may link to the user library 229 whose functions may invoke the peripheral hardware 223 through the kernel 227.

In an embodiment of the present invention, the download agent 215 may be executed as an unprivileged application that interacts with an update driver 213. The update driver 213 may be part of the kernel 227, which may execute in privileged mode and be capable of saving downloaded content, such as an update package into the non-volatile memory 219 employing one or more flash driver(s) 233. The update driver 213 may facilitate the storage of a file containing data/code such as, for example, an update package. The update driver 213 may also retrieve and save information about the stored file in an allocated section of memory called an update package reference. The saved information may include verification information such as, for example, CRC values, MD5 checksum, size information, status information, address information of the location where the file containing the update package may be saved, etc.

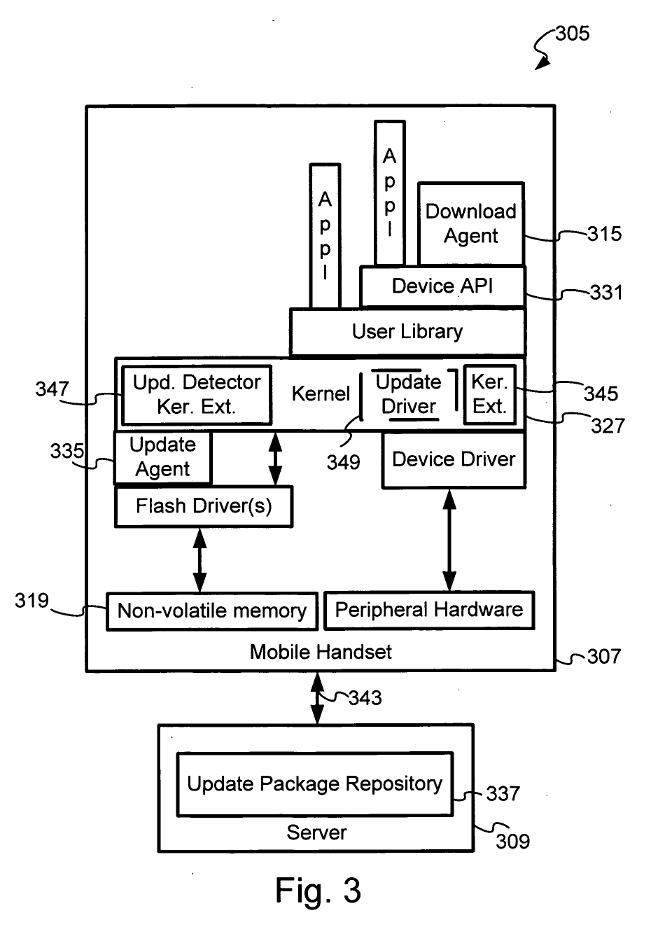

FIG. 3 illustrates a block diagram of the layered architecture of a mobile handset 307 in another exemplary update system 305 for facilitating firmware/software updates in a mobile handset 307, in accordance with an embodiment of the present invention. The update system 305 may comprise a mobile handset 307, with a file system, connected to a server 309 via a communication link 343. In an embodiment of the present invention, the server 309 may host an update package repository 337, which may contain update packages for firmware/software in mobile handsets such as mobile handset 307 connected to the server 309.

In an embodiment of the present invention, the operating firmware/software of mobile handset 307 may comprise several layers of firmware/software. The update of firmware/software may be achieved using an update agent 335. In an embodiment of the present invention, the mobile handset 307 may employ an update detector kernel extension 347 to detect whether an update is needed, by detecting the presence of an update package at boot time. The update detector kernel extension 347 may initiate the update agent 335 at boot time to apply an update to the firmware/software using an update package. The update package may be downloaded by the download agent 315 and saved in a non-volatile memory 319 using an update driver 349, which may be available in the kernel 327.

In an embodiment of the present invention, a kernel extension 345 may be a separate DLL that packages logic used to process user input, which may be provided by a user using peripherals. The user input may provide events consumed by the kernel 327. Different kernel extensions 345 may be written for different devices such as, for example, keyboard, keypad, digitizer, and navigation buttons and wheels.

In an embodiment of the present invention, the update detector kernel extension 347 may be capable of detecting the presence of an update package in the mobile handset 307, thereby providing a mechanism that determines the need to update firmware/software in the mobile handset 307. In another embodiment of the present invention, the update detector kernel extension 347 may be capable of accessing an update package reference comprising update package related information including a flag that indicates the need to update firmware/software in the mobile handset 307.

In an embodiment of the present invention, the update detector kernel extension 347, when added into the image of the mobile handset 307 as part of the kernel 327, may provide a mechanism that determines, at reboot, the need to update firmware/software in the mobile handset 307. The kernel 327 may detect the presence of the update detector kernel extension 347 at boot time and initiate it, thereby providing an opportunity to determine at boot time if an update is necessary. In an embodiment of the present invention, the update detector kernel extension 347 may determine that an update is necessary, and the update agent 335 may as a result be invoked to access an update package and apply updates to firmware/software in the mobile handset 307. The download agent 315 may employ appropriate functions provided by the device API 331 to interact with the update driver 349 to initiate the download of update packages, and to save the downloaded update packages in non-volatile memory 319. In an embodiment of the present invention, the update packages may be downloaded from external systems such as, for example, server 309.

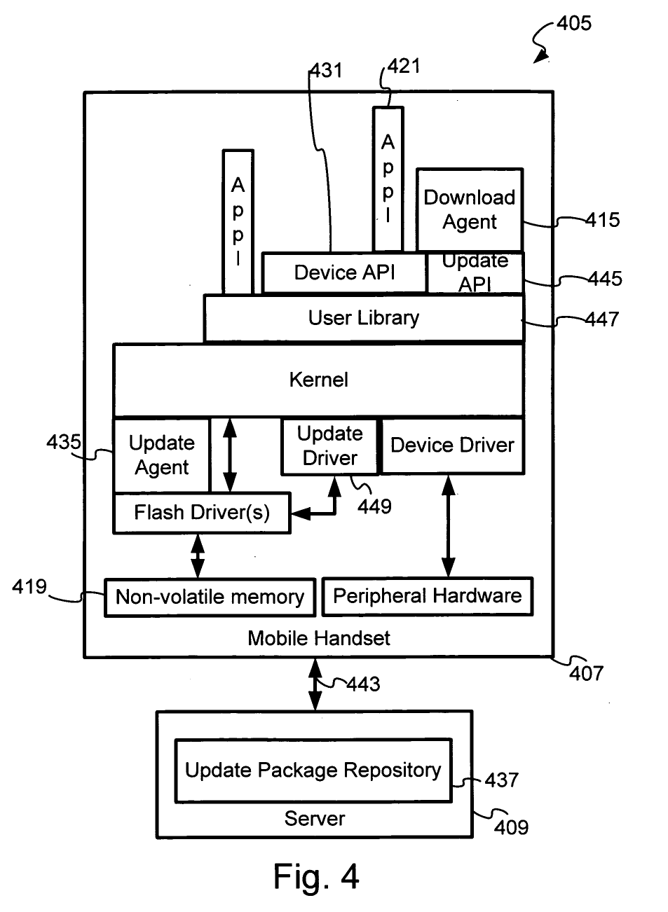

FIG. 4 illustrates a block diagram of the layered architecture of a mobile handset 407 in another exemplary update system 405 for facilitating firmware/software updates, in accordance with an embodiment of the present invention. The update system 405 may comprise a mobile handset 407, with a file system, connected to a server 409 via a communication link 443. In an embodiment of the present invention, the server 409 may host an update package repository 437, which may contain update packages for firmware/software in mobile handsets such as mobile handset 407 connected to the server 409.

In an embodiment of the present invention, the operating firmware/software mobile handset 407 with a file system may comprise several layers of firmware/software. The update of firmware/software may be achieved using an update agent 435. In an embodiment of the present invention, the mobile handset 407 may employ a download agent 415 to download update packages from an external system such as, for example, the server 409. The download agent 415 may then employ an update API 445 that supports, for example, the download of update packages, the verification of downloaded update packages, the storage of update packages in non-volatile memory 419, the retrieval of information related to saved update packages, and the population of an update package reference accessible by an update agent 435. The update API 445 may employ an update driver 449 to save the update packages in the non-volatile memory 419. The update API 445 may also employ the update driver 449 to populate an update package reference with information related to an update package such as, for example, the size of the update package, a CRC value, the location of the update package in memory, the location of a backup section of memory, etc. In an embodiment of the present invention, the update package reference may, for example, be a 16-byte section of memory accessible by the update agent 435.

In an embodiment of the present invention, the update driver 449 may function as a device driver and expose an API such as, for example, the update API 445, to applications such as, for example, the download agent 415, to allow management of update package download and storage in non-volatile memory 419 and other related activities. Device drivers such as, for example, the update driver 449 may be loaded and unloaded at anytime. In an embodiment of the present invention, a device driver such as the update driver 449 may comprise two parts: a library providing a device API such as the device API 431, to which applications such as application 421 can link; and one or more libraries such as, for example, the user library 447, running in privileged mode to access hardware such as, for example, the non-volatile memory 419.

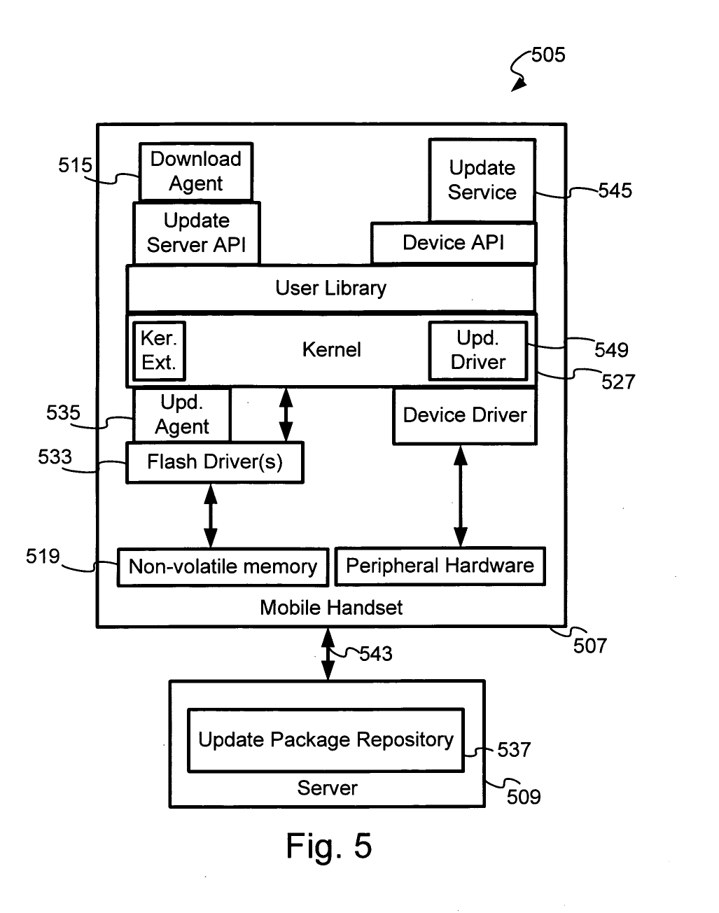

FIG. 5 illustrates a block diagram of the layered architecture of a mobile handset 507 in another exemplary update system 505 for facilitating firmware/software updates in a mobile handset 507, in accordance with an embodiment of the present invention. The update system 505 may comprise a mobile handset 507, with a file system, connected to a server 509 via a communication link 543. In an embodiment of the present invention, the server 509 may host an update package repository 537, which may contain update packages for firmware/software in mobile handsets such as mobile handset 507 connected to the server 509.

In an embodiment of the present invention, the mobile handset 507 may include a file system such as that provided by, for example, the Symbian OS, and may comprise several layers of firmware/software. The update of firmware/software may be achieved using an update agent 535. In an embodiment of the present invention, a download agent 515 in the mobile handset 507 may download an update package and access a system service such as, for example, an update service 545. In an embodiment of the present invention, the update service 545 may be capable of using device drivers such as, for example, the update driver 549 in a kernel 527, to access the flash drivers 533. The flash drivers 533 may be utilized for storage and retrieval of the update package and related information. Access to the update service 545 may be coordinated using a standard client-server framework. In an embodiment of the present invention, the update service 545 may run as a non-privileged thread.

In an embodiment of the present invention, the download agent 515 may be a client connecting to the update service 545 by name, and may communicate via messages passed through a standard interface imposed by the kernel 527. This client-server framework for such interaction may be constructed through inheritance from the update service 545 classes. The update driver 549 may provide support in the kernel 527 for the update package-related client-server interactions. In an embodiment of the present invention, the update service 545 may access the non-volatile memory 519 through the update driver 549 in the kernel 527, which may employ the flash driver(s) 533.

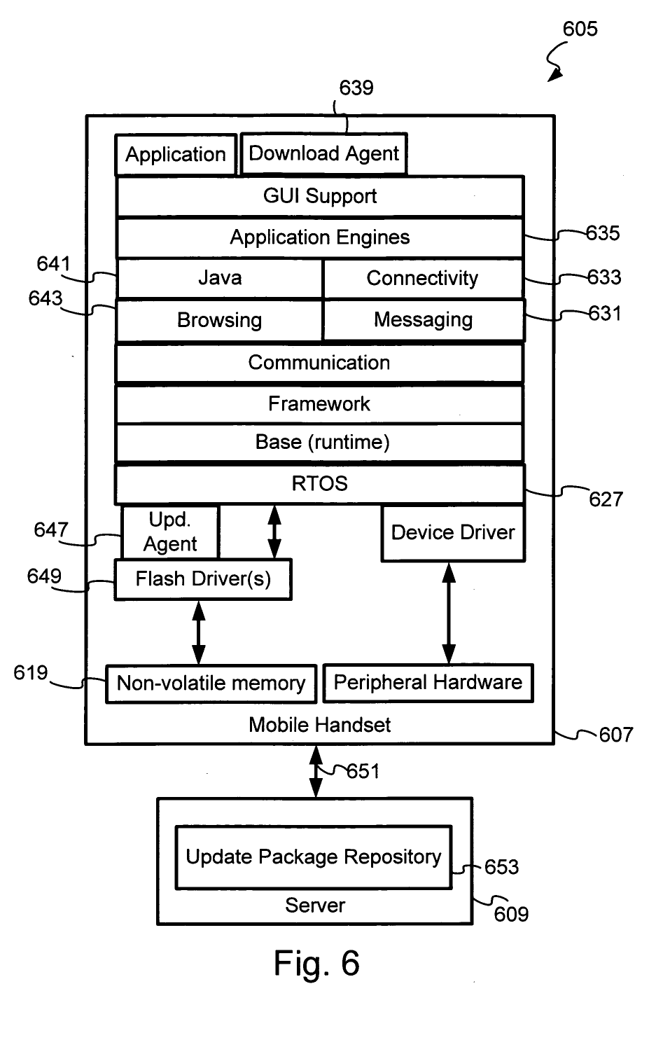

FIG. 6 illustrates a block diagram of the layered architecture of a mobile handset 607 in another exemplary update system 605 for facilitating firmware/software updates in a mobile handset 607, in accordance with an embodiment of the present invention. The update system 605 may comprise a mobile handset 607, with a file system, connected to a server 609 via a communication link 651. In an embodiment of the present invention, the server 609 may host an update package repository 653, which may contain update packages for firmware/software in mobile handsets such as mobile handset 607 connected to the server 609.

In an embodiment of the present invention, the mobile handset 607 may include a file system such as that provided by, for example, the Symbian OS, and may comprise several layers of firmware/software. The update of firmware/software may be achieved using an update agent 647. The update agent 647 may run as a layer below a real-time operating system (RTOS) 627, which may contain an update driver (not shown) for saving update packages and related information. The RTOS 627 may run below an operating system such as, for example, the Symbian OS (not shown). In an embodiment of the present invention, a download agent 639, which may run as an application in an operating system environment, may download an update package and invoke a service or function provided by the RTOS 627 to save the downloaded update package in a non-volatile memory 619 such as, for example, flash memory.

In an embodiment of the present invention, the application engines 635 may comprise an agenda engine, a contacts model, a sheet engine, an alarm and world server, a spell engine, and a help engine. Any component of the application engines 635 may be updated using an appropriate update package that may be downloaded using the download agent 639 and saved in non-volatile memory 619 using RTOS 627. The RTOS 627 may contain an update driver to save the downloaded update package. In an embodiment of the present invention, the Java Virtual Machine (JVM) 641, connectivity solution 633, messaging engine 631, and the browsing engine 643 may also be updated using appropriate update packages.

In an embodiment of the present invention, the download agent 639 may provide a means of authenticating software components that are downloaded. The verification may involve using digital signatures and certificates designed to provide some measure of confidence to ensure authenticity of the components to be installed onto an operating system such as, for example, the Symbian OS. Authentication may comprise verifying the vendor of the installed components. In an embodiment of the present invention, the authentication of software components may be performed based on a CRC value sent to the mobile handset 607 as metadata with the downloaded update package. The received CRC value may then be compared with a locally computed CRC value.

In an embodiment of the present invention, the download agent 639 may ensure that the correct firmware/software is installed onto an appropriate device. In an embodiment of the present invention, the update agent 647 may also ensure that the correct firmware/software is installed onto an appropriate device.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A system that facilitates updating of firmware in an electronic device with a file system, using updating information received from a server via a communication network, the system comprising:
a non-volatile memory comprising the firmware;
an operating system that supports a file system;
loading software that receives the updating information;
driver software that stores the loaded updating information in the non-volatile memory; and
updating software that applies the updating information to the firmware.

2. The system according to claim 1 wherein the server is external to the electronic device.

3. The system according to claim 1 wherein the server comprises a file system internal to the electronic device.

4. The system according to claim 1 wherein the driver software stores information associated with the updating information at a reference location in the non-volatile memory.

5. The system according to claim 4 wherein the reference location is a default location in the non-volatile memory known to the updating software.

6. The system according to claim 4 wherein the reference location is located in the file system in a default file known to the updating software.

7. The system according to claim 4 wherein the updating software employs the information associated with the updating information to retrieve the updating information.

8. The system according to claim 1 wherein the system further comprises a kernel.

9. The system according to claim 8 wherein the kernel executes in a privileged mode.

10. The system according to claim 8 wherein at least a portion of the firmware executes in a non-privileged mode.

11. The system according to claim 8 wherein the kernel determines whether updating of the firmware in the electronic device is necessary, when the electronic device is initialized.

12. The system according to claim 8 wherein the kernel determines whether updating information is available.

13. The system according to claim 12 wherein the kernel invokes the updating software to update the firmware if it determines that updating information is available.

14. The system according to claim 1 wherein the loading software verifies the loaded updating information.

15. The system according to claim 1 wherein the communications network is wireless.

16. The system according to claim 1 wherein the electronic device is portable.

17. The system according to claim 1 wherein the system further comprises a library and the driver software utilizes the library to read and write data from the non-volatile memory.

18. The system according to claim 17 wherein the updating software is capable of utilizing the library to read and write data from the non-volatile memory.

19. The system according to claim 1 wherein the updating information is stored in a continuous block of the non-volatile memory.

20. The system according to claim 19 wherein the continuous block is not used for data storage and retrieval.

21. The system according to claim 1 wherein the loading software employs an application-program interface to perform at least one of the following:
verifying the loaded updating information;
storing the loaded updating information in the non-volatile memory;
retrieving information related to stored updating information; and
storing the retrieved related information in a reference in the non-volatile memory, wherein the reference is accessible by the updating software.

22. A system that facilitates updating of firmware in an electronic device with a file system, using updating information received from a server via a communication network, the system comprising:
a non-volatile memory comprising the firmware;
an operating system that supports a file system;
loading software that receives the updating information;
driver software that stores the loaded updating information in the non-volatile memory and stores information associated with the updating information at a reference location in the non-volatile memory; and
updating software that employs the information associated with the updating information to retrieve the updating information and applies the updating information to the firmware.

23. The system according to claim 22 wherein the system further comprises a kernel that determines whether updating of the firmware in the electronic device is necessary, when the electronic device is initialized.

24. The system according to claim 23 wherein the kernel determines whether updating information is available and invokes the updating software to update the firmware if it determines that updating information is available.

25. A system that facilitates updating of firmware in a portable electronic device with a file system, using updating information received from a server via a wireless communication network, the system comprising:
a non-volatile memory comprising the firmware;
an operating system that supports a file system;
loading software that receives the updating information;
driver software that stores the loaded updating information in the non-volatile memory and stores information associated with the updating information at a reference location in the non-volatile memory;
updating software that employs the information associated with the updating information to retrieve the updating information and applies the updating information to the firmware; and
a kernel that determines whether updating of the firmware in the electronic device is necessary, when the electronic device is initialized.
